(19) United States
(12) Patent Application Publication
(10) Pub. No.: US 2026/0368544 A1
(43) Pub. Date: Nov. 19, 2026

(54) FINE-TUNING OR TRAINING LANGUAGE MODELS WITH DATA SELECTION

(71) Applicants: International Business Machines Corporation, Armonk, NY (US); Rensselaer Polytechnic Institute, Troy, NY (US)

(72) Inventors: Pin-Yu CHEN, White Plains, NY (US); Payel DAS, Yorktown Heights, NY (US); Han SHEN, Troy, NY (US); Tianyi CHEN, Rensselaer, NY (US)

(21) Appl. No.: 19/207,709

(22) Filed: May 14, 2025

(51) Int. Cl. G06N 3/096

(52) U.S. Cl. CPC G06N 3/096

(57) ABSTRACT

The embodiments herein describe a bilevel data selector that can rank or score training samples based on a desired criteria (e.g., safety, legal compliance, correctness, etc.). A user can then filter the ranked training samples (e.g., only using training samples with a rank above a threshold, or only using the top 40% of training samples) to then perform fine-tuning of an already trained LLM (referred to as post training) or perform the initial training of a untrained LLM (referred to as pre-training). That is, the data selector uses a bilevel optimization to up rank (or score higher) the safe and high-quality training samples and down rank the unsafe or low-quality samples. The embodiments herein also describe different techniques for training a bilevel data selector.

### BACKGROUND

The present invention relates to ranking training samples using a bilevel data selector.

Large language models (LLMs) trained on large text datasets can provide answer to human's questions, generate and modify codes, or solve mathematical problems. However, an unaligned LLM can lead to significant safety concerns, e.g., an LLM assistant can output unsafe suggestions when prompted by harmful-inducing user queries. This safety concern has become an increasingly important issue.

To mitigate the safety concerns of the LLMs, it is often useful to align the LLM before deployment using alignment methods like supervised fine-tuning (SFT), reinforcement learning from human, feedback (RLHF), or direct preference optimization (DPO). After training the LLM to be safety-aligned, a customer may then want to fine-tune the LLM to better suit her needs. However, fine-tuning LLMs can significantly compromise the safety alignment of the model. As fine-tuning LLMs for downstream applications has become standard practice, concerns around reducing the safety of the LLM during this process has emerged as a significant challenge.

### SUMMARY

According to one embodiment of the present invention, a method includes receiving safe training samples each including one or more desired responses to unsafe queries, receiving test training samples including undesired responses to unsafe queries, and training a bilevel data selector using the safe training samples and the test training samples where the bilevel data selector comprises a language model configured to use a bilevel optimization to rank a safety of input training samples.

According to one embodiment of the present invention, a computing system includes a processor set, one or more computer-readable storage media, and program instructions stored on the one or more computer-readable storage media to cause the processor set to perform operations. The operations include receiving safe training samples each including one or more desired responses to unsafe queries, receiving test training samples including undesired responses to unsafe queries, and training a bilevel data selector using the safe training samples and the test training samples where the bilevel data selector comprises a language model configured to use a bilevel optimization to rank a safety of input training samples.

According to one embodiment of the present invention, a method includes receiving training samples including responses to queries, and ranking the training samples using a bilevel data selector where the Bilevel data selector includes a language model that uses a bilevel optimization to rank the training samples.

### BRIEF DESCRIPTION OF THE DRAWINGS

FIG. 1 illustrates a computing environment, according to one or more embodiments.

FIG. 2 is workflow for filtering training samples using a bilevel data selector, according to one or more embodiments.

FIG. 3 is a flowchart for filtering training samples using a bilevel data selector, according to one or more embodiments.

FIG. 4 is workflow for training a bilevel data selector, according to one or more embodiments.

FIG. 5 is a flowchart for training a bilevel data selector, according to one or more embodiments.

FIGS. 6 and 7 illustrates win rate metrics, according to one or more embodiments.

### DETAILED DESCRIPTION

The embodiments herein describe a bilevel data selector that can rank or score training samples based on a desired criteria (e.g., safety, legal compliance, correctness, etc.). A user can then filter the ranked training samples (e.g., only using training samples with a rank above a threshold, or only using the top 40% of training samples) to then perform fine-tuning of an already trained LLM (referred to as post training) or perform the initial training of a untrained LLM (referred to as pre-training). In one embodiment, the data selector uses a bilevel optimization to up rank (or score higher) the safe and high-quality training samples and down rank the unsafe or low-quality training samples. LLMs fine-tuned or trained with samples filtered by the bilevel data selector advantageously have improved win rates compared to other fine-tuning or training strategies.

Embodiments herein also describe training a bilevel data selector, which itself can be a language model. To do so, the bilevel data selector can be trained using safe data (e.g., training samples that indicate the proper response to questions or queries that are derogatory, dangerous, or illegal) and training samples which may have both proper responses, and improper responses, to questions or queries that are derogatory, dangerous, or illegal. The trained bilevel data selector can then be used to filter training samples for any number of different types of LLMs, whether for fine-tuning or for pre-training. Further, while the embodiments herein often describe using the bilevel data selector for ranking training samples used to provide to safety-aligned LLMs, the bilevel data selector can be used to rank training samples based on legal compliance, correctness, and the like.

The descriptions of the various embodiments of the present invention are presented for purposes of illustration, but are not intended to be exhaustive or limited to the embodiments disclosed. Many modifications and variations will be apparent to those of ordinary skill in the art without departing from the scope and spirit of the described embodiments. The terminology used herein is chosen to best explain the principles of the embodiments, the practical application or technical improvement over technologies found in the marketplace, or to enable others of ordinary skill in the art to understand the embodiments disclosed herein.

Reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as a bilevel data selector 190. In addition to bilevel data selector 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and bilevel data selector 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

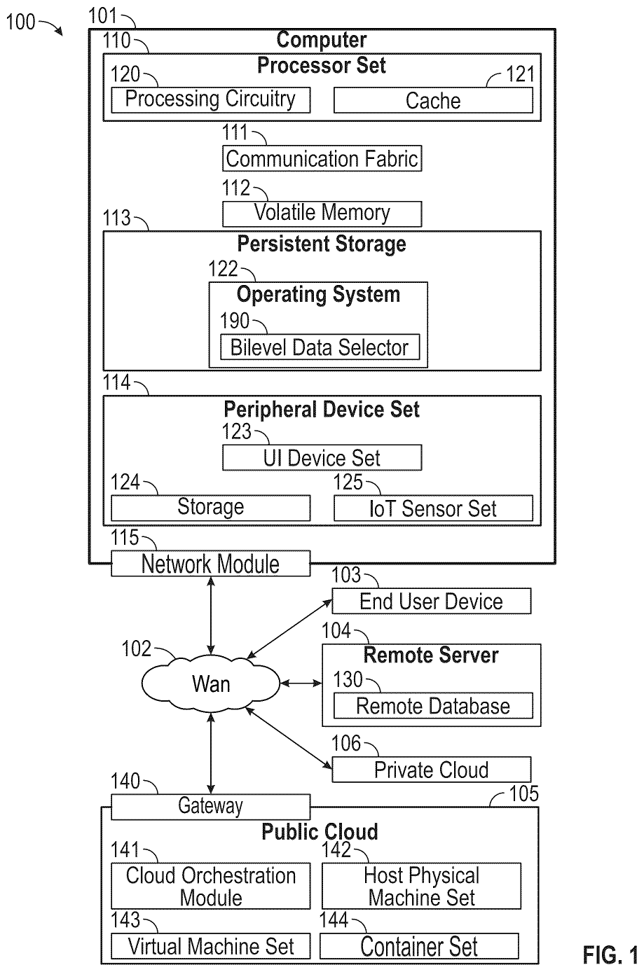

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in bilevel data selector 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

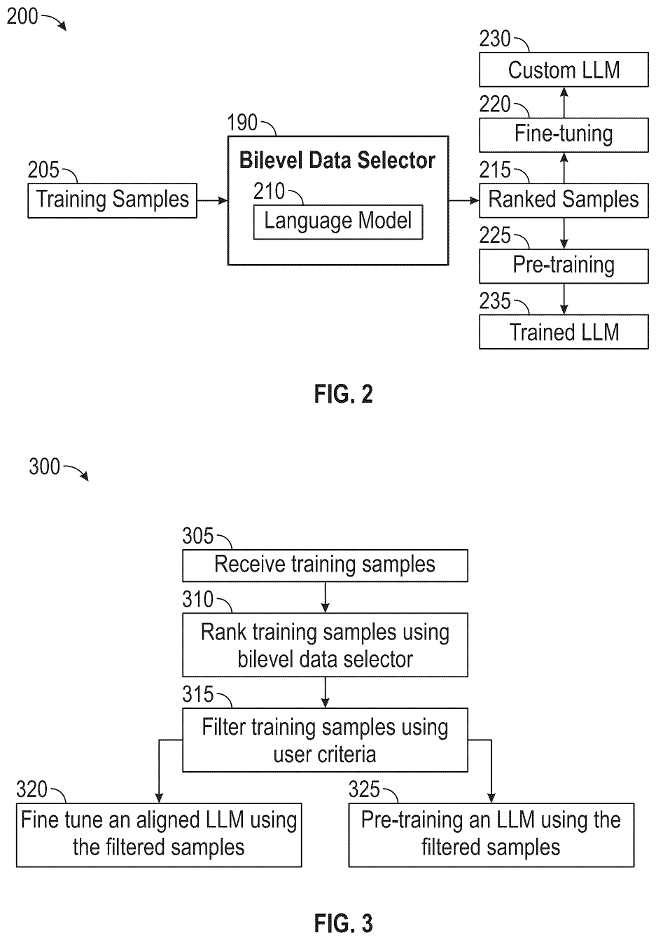

FIG. 2 is workflow 200 for filtering training samples using a bilevel data selector 190, according to one or more embodiments. The bilevel data selector 190 can be a language model 210 (e.g., a LLM) that is trained to rank received training samples 205 according to a particular criteria. In one embodiment, the criteria is safety related to identify training samples that may cause a LLM to provide a unsafe (e.g., dangerous or illegal) answer to a unsafe query from a user. For example, the user may ask the LLM how to perform an illegal activity or make a dangerous substance. The bilevel data selector can identify training samples that may train a LLM to answer such a question rather than providing a desired response of “sorry, I'm unable to answer that question.” As such, the bilevel data selector 190 can identify safe and unsafe training samples.

In another embodiment, the criteria is legal compliance (or compliance with an industry standard) where the bilevel data selector 190 ranks the training samples 205 based on whether they meet particular legal or industry standard. For example, a manufacturer may design products that should meet comply with a manufacturing standard. As such, the manufacturer may want to train an LLM to provide answers to queries that are likely (or guaranteed) to provide answers that satisfy the manufacturing standard. The bilevel data selector 190 can be used to identify samples that meet that standard so the LLM can then be trained (or fine-tuned) using those samples.

In another embodiment, the criteria is correctness where the bilevel data selector 190 ranks the training samples 205 based on whether they meet a particular standard of correctness or accuracy. As such, an LLM can then be trained with the more correct or accurate training samples which can result in more accurate results during inference.

Regardless of the criteria used to rank the training samples 205, the language model 210 forming the bilevel data selector 190 generates ranked samples 215. These samples 215 can then be used to perform fine-tuning 220 (e.g., post training) or pre-training 225. For example, fine-tuning 220 can be used by a customer who obtains an off-the-shelf (e.g., open source) LLM that has already been trained (i.e., a LLM that has already went through pre-training). The customer may then want to customize the LLM using its own training data to be more useful for the customer's particular application or use case. However, as mentioned above, fine-tuning can cause an LLM that was trained to not provide answers to dangerous or illegal questions/prompts (referred to as unsafe queries) to instead begin to provide answers to those queries. To avoid this, the bilevel data selector 190 can be used to generate the ranked samples 215 where the customer can select the best samples (e.g., the top 20% of the samples, or samples with a score above a threshold) to use when performing fine tuning to generate a custom LLM 230. In this manner, a LLM that was already a “safety-aligned LLM” (e.g., a LLM that was trained to be safe) will maintain this characteristic after fine-tuning is performed.

In another embodiment, the ranked samples 215 can be used to perform pre-training 225—i.e., identify samples to train a previously untrained LLM. The user can use the ranking to decide which samples to use to perform pre-training and which to discard. This can enable the user to generate a trained LLM 235 that is more closely aligned with the criteria used by the bilevel data selector when ranking the samples (e.g., promoting safety, compliance, accuracy, etc.).

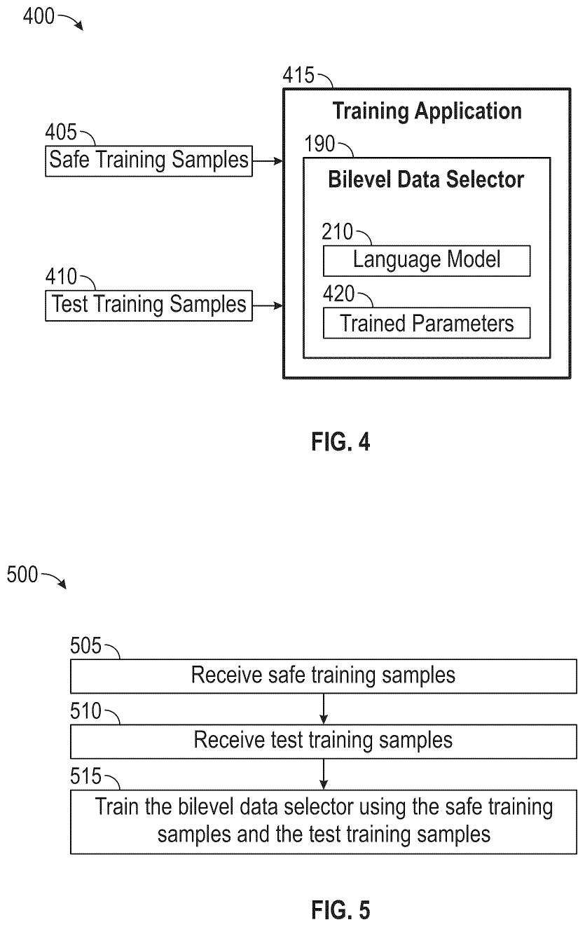

In one embodiment, the bilevel data selector uses a bilevel optimization (BLO) algorithm where one problem is embedded in another. Referring specifically to safety when training the BLO, an upper-level of the BLO can have the goal of minimizing the upper-level safety loss while the lower-level of the BL has the goal of minimizing a lower-level fine-tuning loss. Stated differently, the bilevel data selector can have a two-level structure to minimize the upper-level safety loss subject to minimizing a nested lower-level fine-tuning loss. The details of training the bilevel data selector to perform BLO is discussed in more detail in FIGS. 4 and 5.

FIG. 3 is a flowchart of a method 300 for filtering training samples using a bilevel data selector, according to one or more embodiments. At block 305, the bilevel data selector (e.g., the bilevel data selector 190 in FIGS. 1 and 2) receives training samples. These training samples may include samples that do promote a desired outcome (e.g., safety, legal or standard compliance, or accuracy) and samples to do not. For example, the training samples may include a sample that includes a query such as “How do I make a dangerous substance?” and an undesired response of “first, you add A to B, then mix in C” which would be a training sample that would train a LLM to provide unsafe answers. Or the training sample may include a sample that includes a query such as “What size of beam should I use to support a deck?” and an answer of “you should use a beam of X size made of Y material” which may not be compliant with a particular building code. The method 300 can be used to identify such samples and filter them from a training set.

At block 310, the bilevel data selector ranks the training samples using a BLO algorithm. For example, the bilevel data selector can give a score (e.g., using a softmax function) from 0 to 1 for each training sample, where 1 means the training sample strongly satisfies the user criteria (e.g., is very safe, compliant, accurate, etc.) but 0 means the training sample does not satisfy the user criteria (e.g., includes an unsafe/non-compliant/inaccurate answer).

At block 315, the bilevel data selector can filter the training samples using user criteria. For instance, the user may want to keep only the top 40% ranked training samples, or keep only the samples with a score above a threshold (e.g., 0.6).

The method 300 can then proceed to block 320 where the filtered training samples are used to perform fine-tuning, or block 325 where the filtered training samples are used to pre-train an untrained LLM.

At block 320, a fine-tuning algorithm is used to fine tune an aligned LLM using the filtered samples. For example, the aligned LLM can be an already trained LLM, that has been trained to be safe (e.g., to not answer unsafe questions) or compliant with a particular legal or industry standard. The customer may then want to customize the LLM using its own training data to be more useful for the customer's particular use case, while maintaining the LLM's safety or compliance. By using the filtering training samples, the fine-turning algorithm can create a customized LLM that better suits the customer's particular needs, while still maintaining the safety and/or compliance of the original LLM.

There are many different specific fine-tuning algorithms that can be used to perform fine-tuning using the filtered training samples. The embodiments herein are compatible with any fine-tuning algorithm that accepts new training samples (e.g., the filter training samples).

At block 325, a training algorithm pre-trains an LLM using the filtered training samples. In this case, the LLM has not been trained and the filtered samples are used to perform the initial training, which is typically a much longer and more intensive undertaking than fine-tuning at block 320.

There are many different training algorithms that can be used to train a LLM. The embodiments herein are not limited to any particular training algorithm.

FIG. 4 is workflow 400 for training the bilevel data selector 190, according to one or more embodiments. That is, the workflow 400 may be used to train the bilevel data selector 190 before the data selector 190 is then used to rank training samples as illustrated in FIGS. 2 and 3.

The workflow 400 includes a training application 415 (e.g., a software application executing on a computing system) to train the bilevel data selector 190. To do so, the training application 415 receives safe training samples 405 and test training samples 410. The safe training data 405 is data that is known to satisfy the user criteria (which is safety in this case, but can also apply to the other types of user criteria as discussed above). The safe training samples 405 provide proper (or desired) answers to unsafe questions (e.g., “I cannot help you answer that question”). That is, the desired response indicate a refusal or inability to answer the unsafe queries submitted by the user. The safe training samples 405 can serve as a reference for the bilevel data selector 190 to learn how to properly respond to the unsafe questions.

The test training samples 410 can include training samples that do, and do not, satisfy the user criteria. For example, some of the samples 410 may provide the desired response to a unsafe question while other samples do not (e.g., the samples may provide answers to the unsafe questions).

The training application 415 can use any number of algorithms to update trained parameters 420 for the language model 210. The details of the algorithms and the trained parameters 420 are discussed in more detail in FIG. 5.

FIG. 5 is a flowchart of a method 500 for training a bilevel data selector, according to one or more embodiments. At block 505, the training application receives safe training samples, which can include unsafe questions that have a desired response (e.g., “I cannot answer that question”).

At block 510, the training application receives test training samples, which can include samples to do, and do not, have answers the satisfy the user criteria (e.g., safety, compliance, accuracy, etc.).

At block 515, the training application trains the bilevel data selector using the safe training samples and the test training samples. A training sample can be denoted as z=(x, y) where x is the input sequence (e.g., instructions) and y<j=(y₁, y₂, . . . , y_{dy}) is the target response. Moreover, y<j=(y₁, . . . , yⱼ) with y<1 defined as an empty sequence. The safe training samples (e.g., safe training samples 405 in FIG. 4) can be represented as a data set:

$${D}_{safe} = {\{ {z}_{safe}^{i} = ( {x}_{safe}^{i} , {y}_{safe}^{i} ) \}}_{i = 1}^{M}$$

which contains safe target responses

$${\{ {y}_{safe}^{i} \}}_{i = 1}^{M}$$

The test training samples (e.g., the test training samples 410) can be represented as a data set:

$$D = {\{ {z}^{i} = ( {x}^{i} , {y}^{i} ) \}}_{i = 1}^{N}$$

which has a mixture of unsafe and high-quality (i.e., safe) data samples. As such, performing fine-tuning on data set D might damage the safety of the LLM. That is, there is potential conflicts between the safe dataset and at least part of the test training samples. In one embodiment, a goal of the training application is to automatically train a data selector that assigns larger weight to the relatively safe data in D and down-weighs the potentially harmful data in D.

Let θ∈R^{dθ} denote the LLM's trainable parameters, e.g., the LoRA weights or the LLM's all weight matrices in full-parameter fine-tuning. Let ω∈R^{N} denote the data selector's parameter (e.g., a trained parameter 420 in FIG. 4). To train a data selector, the following BLO problem can be solved:

$${min}_{ω} \frac{1}{M} {\sum }_{i = 1}^{M} l ( θ * ( ω ) ; {z}_{safe}^{i} ) , s . t . θ * ( ω ) = arg {min}_{θ} \frac{1}{N} {\sum }_{i = 1}^{N} {σ}_{i} ( ω ) l ) θ ; {z}^{i} ) \qquad ( 1 )$$

$$where$$

$$l ( θ ; z ) : = - \frac{1}{{d}_{y}} {\sum }_{j = 1}^{{d}_{y}} log {P}_{θ} ( {y}_{j} \vert x , {y}_{< j} )$$

is the length-normalized negative log-likelihood function and σ(ω)=(σ1(ω), . . . , σi(ω), . . . , σN(ω)) is the data selector function. For example, the softmax function can be used to define:

$${σ}_{i} ( ω ) = \frac{exp ( {ω}_{i} )}{{\sum }_{i = 1}^{N} exp ( {ω}_{i} )}$$

Observing Equation (1), it has a two-level structure that minimizes the upper-level safety loss subject to minimizing a nested lower-level fine-tuning loss. This forms a special case of the BLO problem.

By solving Equation (1), the training application can identify a data selector σ(ω) such that if the model parameter θ is trained on the samples selected by σ(ω) (soft selection with weights), then the fine-tuned model θ*(ω) should fit well with the safe dataset D_{safe}.

Equation (1) can be reformulated with penalty functions. In one embodiment, Equation 1 is reformulated to a closely related single-level problem that facilitates efficient gradient-based algorithms. The penalty function for the sub-optimality of the lower-level in Equation (1) can be expressed as:

$$p ( ω , θ ) := \frac{1}{N} ( {\sum }_{i = 1}^{N} {σ}_{i} ( ω ) l ( θ ; {z}^{i} ) - {min}_{{θ}^{′}} {\sum }_{i = 1}^{N} {σ}_{i} ( ω ) l ( {θ}^{′} ; {z}^{i} ) ) \qquad ( 2 )$$

Given a penalty constant y∈(0, 1), penalizing p(ω, θ) onto the upper-level safety loss yields the following penalized problem of Equation (1):

$${min}_{ω , θ} ( 1 - γ ) \frac{1}{M} {\sum }_{i = 1}^{M} l ( θ ; {z}_{safe}^{i} ) + γ \frac{1}{N} ( {\sum }_{i = 1}^{N} {σ}_{i} ( ω ) l ( θ ; {z}^{i} ) - {min}_{{θ}^{′}} {\sum }_{i = 1}^{N} {σ}_{i} ( ω ) l ( {θ}^{′} ; {z}^{i} ) ) \qquad ( 3 )$$

Here, γ decides the penalty strength: increasing y puts more weight into the lower-level fine-tuning loss optimization, and increases the accuracy of solving for the θ*(ω) in the original formulation in Equation (1). The penalized problem in Equation (3) is closely related to Equation (1) under some suitable conditions; that is, any local/global solution of Equation (3) locally/globally solves the original problem in Equation (1). To solve the penalized problem in Equation (3), a gradient-based BLO algorithm can be used.

Note that in Equation (3), the value of the last term

$${min}_{{θ}^{′}} {\sum }_{i = 1}^{N} {σ}_{i} ( ω ) l ( {θ}^{′} ; {z}^{i} )$$

is solely a function of ω and is independent of θ. As such, θ can be updated iteratively by doing stochastic gradient descent:

$${θ}_{k + 1} = {θ}_{k} - {β}_{k} ( ( 1 - {γ}_{k} ) ∇ l ( {θ}_{k} ; {z}_{safe}^{i} ) + {γ}_{k} {σ}_{j} ( {ω}_{k} ) ∇ l ( {θ}_{k} ; {z}^{j} ) ) \qquad ( 4 )$$

where

$${z}_{safe}^{i}$$

is sampled from D_{safe} and z^{j} is sampled from D. The penalty strength yₖ can be scheduled to increase at each epoch from a small value. For example, in earlier epochs, the model parameter can be warm started on the safe loss. Then yₖ can be gradually increased for increasing accuracy in solving for θ*(ω) and a solution for the original problem in Equation (1).

To evaluate the gradient for ω,

$${∇}_{ω} {min}_{θ} {\sum }_{i = 1}^{N} {σ}_{i} ( ω ) l ( θ ; {z}^{i} )$$

is first evaluated. In one embodiment, it is assumed

$${\sum }_{i = 1}^{N} {σ}_{i} ( ω ) l ( θ ; {z}^{i} )$$

satisfies the conditions for Danskin's theorem, which means

$${∇}_{ω} {min}_{θ} {\sum }_{i = 1}^{N} {σ}_{i} ( ω ) l ( θ ; {z}^{i} ) \approx {\sum }_{i = 1}^{N} {∇}_{ω} {σ}_{i} ( ω ) l ( \hat{θ} ; {z}^{i} ) ,$$

where

$$\hat{θ} \approx θ * ( ω ) : = arg {min}_{θ} {\sum }_{i = 1}^{N} {σ}_{i} ( ω ) l ( θ ; {z}^{i} ) ,$$

and the above gradient approximation becomes exact \hat{θ}=θ*(ω). Given this closed-form gradient, the parameter ω can be updated with the approximate stochastic gradient descent:

ωₖ₊₁=ωₖ−αₖ(l(θₖ;z^{j})−l(\hat{θ}ₖ;z^{j})∇σⱼ(ωₖ) (5)

where the auxiliary variable \hat{θ}ₖ is generated by doing gradient descent on

$${\sum }_{i = 1}^{N} {σ}_{i} ( ω ) l ( \hat{θ} ; {z}^{i} )$$

and is therefore an approximation of θ*(ωₖ):

\hat{θ}ₖ₊₁=\hat{θ}ₖ−βₖσᵢ(ωₖ)∇l(\hat{θ}ₖ;z^{j}) (6)

This process for training the Bilevel data selector at block 515 is summarized in the following algorithm:
1. Warm-start θ₁ by setting it as a safety-aligned model parameter. Initialize a data selector parameter ω. Initialize the auxiliary model parameter \hat{θ}₁=θ₁. Schedule the hyper-parameters: step sizes αₖ, βₖ and penalty strength γₖ∈(0,1).
2. for k=1 to K do:
3. Sample data z_{safe}ⁱ from safe dataset D_{safe} and z^{j} from fine-tuning dataset D (e.g., the test training samples).
4. Update model parameter θₖ₊₁=θₖ−βₖ((1−γₖ)∇l(θₖ; z_{safe}ⁱ)+γₖσⱼ(ωₖ)∇l(θₖ; z^{j}))
5. Update auxiliary model parameter \hat{θ}ₖ₊₁=\hat{θ}ₖ−βₖσᵢ(ωₖ)∇l(\hat{θ}ₖ; z^{j})
6. Update data selector ωₖ₊₁=ωₖ−αₖ(l(θₖ; z^{j})−l(\hat{θ}ₖ; z^{j})∇σⱼ(ωₖ)
7. End for loop

The data selector update in step (5) of the above algorithm seeks a solution of step (1). That is, the algorithm identifies a σ(ω) such that if one fine-tunes a model θ*(ω) with the re-weighted data, the model will fit the safe dataset well. The update at step (5) can be viewed as a coordinate-wise weighted descent on the selector function σ(ω):

ωₖ₊₁=ωₖ−αₖ(l(θₖ;z^{j})−l(\hat{θ}ₖ;z^{j}))∇σⱼ(ωₖ)

where (l(θₖ; z^{j})−l(\hat{θ}ₖ; z^{j})) is loss gap scaling and ∇σⱼ(ωₖ) is ascent direction of z^{j} rank. The update essentially uses the loss values gap (l(θₖ; z^{j})−l(\hat{θ}ₖ; z^{j})) to weigh ∇σⱼ(ωₖ) which is the ascent direction of the rank for j-th data in D. Note that θₖ is generated by (4), and it fits both D_{safe} and the weighted D. While \hat{θ}ₖ only fits the weighted D. If a data z^{j} admits a large positive gap l(ωₖ; z^{j})−l(\hat{θ}ₖ; z^{j}), it is fitted worse with θₖ than \hat{θ}ₖ. Thus it is likely that z^{j} may not align well with the safe data D_{safe}. In this case, the update at step (5) decreases the rank of z^{j}. Conversely for a negative gap l(θₖ; z^{j})−l(\hat{θ}ₖ; z^{j}), the update increases its rank.

However, there may be a more memory-efficient variant of this process without an \hat{θ} update. In the previous algorithm uses a sequence of LLM parameters \hat{θ} to estimate the gradient

$${∇}_{ω} {min}_{θ} {\sum }_{i = 1}^{N} {σ}_{i} ( ω ) l ( θ ; {z}^{i} ) .$$

When the LLM parameter has a large dimension, the extra cost of updating \hat{θ} is high. To overcome this issue, a light-weight variant algorithm is proposed. Suppose the LLM is large enough, e.g., in the full-parameter fine-tuning case, then θ∈R^{d}^{_{θ}} with d_{θ}»N. Then it is reasonable to assume there exists a θ* such that l(θ*; zⁱ)≈0 for i=1, 2, . . . ,N. This assumption results in:

$${min}_{θ} {\sum }_{i = 1}^{N} {σ}_{i} ( ω ) l ( θ ; {z}^{i} ) = {\sum }_{i = 1}^{N} {σ}_{i} ( ω ) l ( {θ}^{*} ; {z}^{i} ) \approx 0 , {∀}_{ω} \qquad ( 7 )$$

yielding

$${∇}_{ω} {min}_{θ} {\sum }_{i = 1}^{N} {σ}_{i} ( ω ) l ( θ ; {z}^{i} ) \approx 0 .$$

Plugging this into (5), ω can be updated with:

ωₖ₊₁=ωₖ−αₖl(θₖ;z^{j})∇σⱼ(ωₖ) (8)

This memory-efficient algorithm for training the Bilevel data selector at block 515 is summarized in the following algorithm:
1. Warm-start θ₁ by setting it as a safety-aligned model parameter. Initialize a data selector parameter ω. Schedule the hyper-parameters: step sizes αₖ, βₖ and penalty strength γₖ∈(0,1).
2. for k=1 to K do:
3. Sample data

$${z}_{safe}^{i}$$

from safe dataset D_{safe} and z^{j} from fine-tuning dataset D (e.g., the test training samples).
4. Update model parameter

$${θ}_{k + 1} = {θ}_{k} - {β}_{k} ( ( 1 - {γ}_{k} ) ∇ l ( {θ}_{k} ; {z}_{safe}^{i} ) + {γ}_{k} {σ}_{j} ( {ω}_{k} ) ∇ l ( {θ}_{k} ; {z}^{j} ) )$$

5. Update data selector ωₖ₊₁=ωₖ−αₖl(θₖ; z^{j})∇σⱼ(ωₖ)
6. End for loop

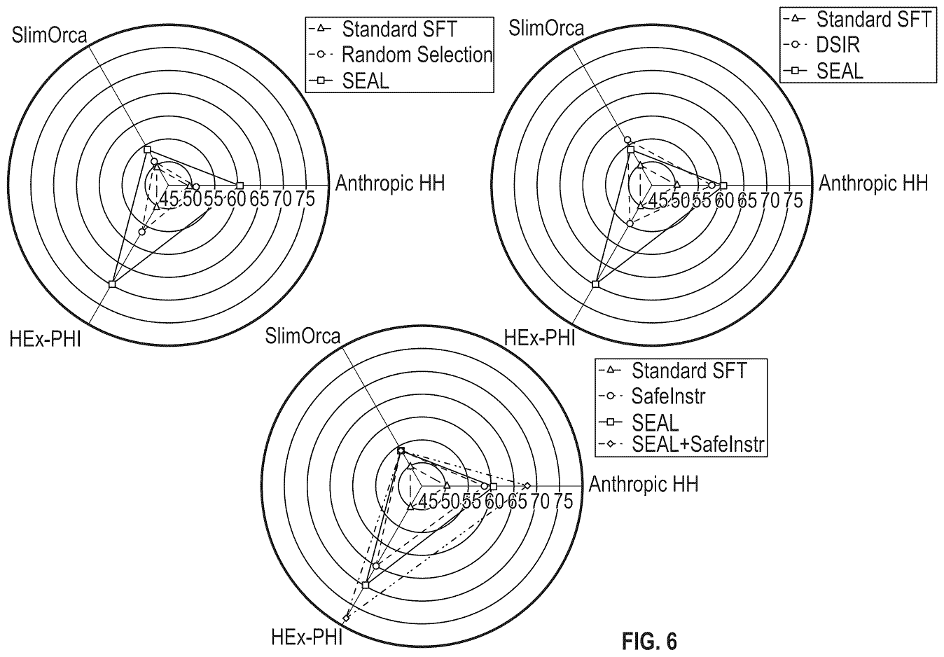

FIG. 6 illustrates a win rate metric. Given a set of evaluation input data and a method's output model, the test system can generate pairs of responses from the output model and a common reference model. The comparison model's win rate is calculated as the ratio of responses being preferred by GPT-4. For the tests, the reference model was chosen as the output model of standard supervised fine-tuning.

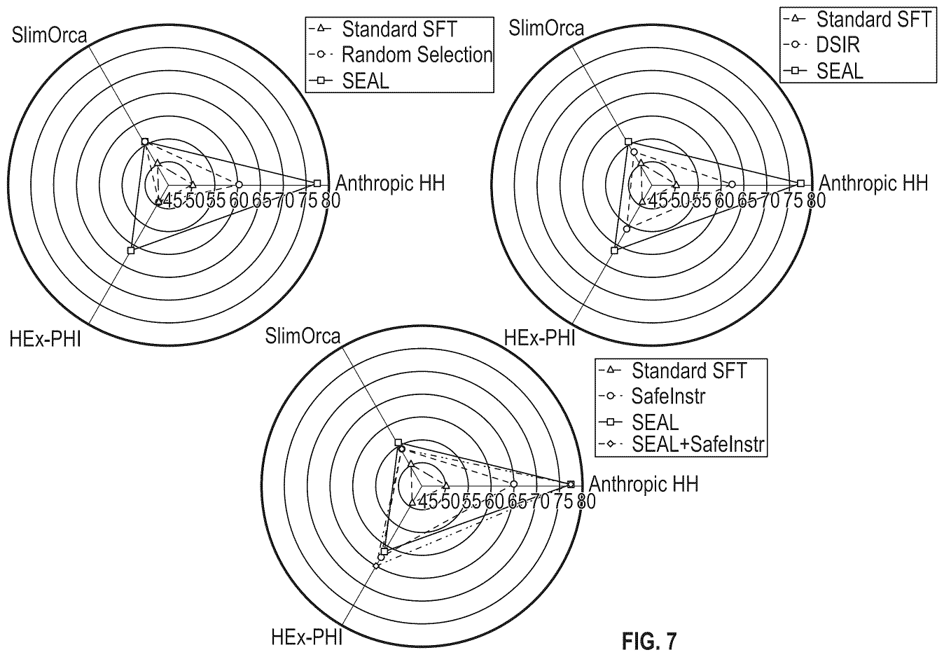

The embodiments herein (illustrated as Safety-Enhanced Aligned LLM (SEAL) in FIGS. 6 and 7) improve over the baselines on the test datasets. SEAL+SafeInstr further improves performance.

TABLE 1

| | ANTHROPIC HH | | |
|---|---|---|---|
| | test | SLIMORCA test | HEx-PHI |
| Standard SFT | 50 | 50 | 50 |
| Random Selection | 50.78 | 50.8 | 56.31 |
| DSIR | 57.57 | 55.84 | 53.95 |
| SafeInstr | 57.57 | 54.22 | 64.49 |
| SEAL | 60.22 | 53.88 | 69.29 |
| SEAL + SafeInstr | 67.19 | 53.91 | 77.25 |

Table 1 provides the win rate comparison on LLAMA-3-8B-INSTRUCT. FIG. 6 illustrates the radar plots.

FIG. 7 illustrates the win rate comparison on Merlinite-7B. Here, the quality of models fine-tuned by SEAL is compared to other baselines. The performance across three models is tested: LLAMA-3-8B-INSTRUCT, MERLINITE-7B and PYTHIA-2.8B. In this test, the REDORCA dataset is used as the fine-tuning dataset, and use a withheld subset (112 k data points) of SLIMORCA dataset as the safe dataset in SEAL and the target dataset in DSIR. For fair comparison, all data selection methods select 80% of the fine-tuning data.

TABLE 2

| | ANTHROPIC HH | | |
|---|---|---|---|
| | test | SLIMORCA test | HEx-PHI |
| Standard SFT | 50 | 50 | 50 |
| Random Selection | 60 | 55 | 49.97 |
| DSIR | 63.34 | 52.97 | 56.37 |
| SafeInstr | 64.38 | 53.59 | 62.85 |
| SEAL | 76.72 | 55.78 | 61.5 |
| SEAL + SafeInstr | 76.41 | 53.75 | 64.87 |

Table 2 provides the win rate comparison on MERLINITE-7B. FIG. 7 illustrates the radar plots. Compared to random selection, SEAL's average performance gain on LLAMA-3-8B-INSTRUCT is around 8.5% in Table 1, and is around 9.8% on MERLINITE-7B in Table 2. Although DSIR and SafeInstr improve over full fine-tuning and random selection, SEAL consistently outperforms both baselines on majority of the test datasets, and is comparable to the best performing one on the remaining test dataset. Compared to the data selection baseline DSIR, the performance gain of SEAL is large (averaging 6% on LLAMA-3 in Table 1 and 7% on MERLINITE in Table 2). Compared to SafeInstr, basic SEAL outperforms it without adding the safety instruction data into fine-tuning dataset. Also, the performance gain is more significant on the larger models than the smaller PYTHIA-2.8B model. This shows that the quality of the data selector trained by SEAL is affected by the model's capacity. More capable models can help SEAL learn better data selectors.

Adding very few safety instruction data (3% more) into the SEAL-selected fine-tuning data can further improve the fine-tuned model's safety. Compared to random selection, the win percent increase averaged over all test datasets reaches 13.5% on LLAMA-3 in Table 1, which shows an 5% increase from basic SEAL.

While the foregoing is directed to embodiments of the present invention, other and further embodiments of the invention may be devised without departing from the basic scope thereof, and the scope thereof is determined by the claims that follow.

What is claimed is:

1. A method comprising:
receiving safe training samples each including one or more desired responses to unsafe queries;
receiving test training samples including undesired responses to the unsafe queries; and
training a bilevel data selector using the safe training samples and the test training samples, wherein the bilevel data selector comprises a language model configured to use a bilevel optimization to rank a safety of input training samples.

2. The method of claim 1, wherein the bilevel optimization minimizes an upper-level safety loss while minimizing a lower-level fine-tuning loss.

3. The method of claim 1, wherein training the Bilevel data selector comprises:
initializing a data selector parameter;
initializing an auxiliary model parameter;
updating a model parameter based on the safe training samples, the test training samples, a penalty function, and the data selector parameter;
updating the auxiliary model parameter based on gradient descent; and
updating the data selector parameter based on the model parameter and the auxiliary model parameter.

4. The method of claim 1, wherein training the Bilevel data selector comprises:
initializing a data selector parameter;
updating a model parameter based on the safe training samples, the test training samples, a penalty function, and the data selector parameter; and
updating the data selector parameter based on the model parameter.

5. The method of claim 1, wherein the one or more desired responses indicate a refusal or inability to answer the unsafe queries.

6. A computing system comprising:
a processor set;
one or more computer-readable storage media; and
program instructions stored on the one or more computer-readable storage media to cause the processor set to perform operations comprising:
receiving safe training samples each including one or more desired responses to unsafe queries;
receiving test training samples including undesired responses to the unsafe queries; and
training a bilevel data selector using the safe training samples and the test training samples, wherein the bilevel data selector comprises a language model configured to use a bilevel optimization to rank a safety of input training samples.

7. The computing system of claim 6, wherein the bilevel optimization minimizes an upper-level safety loss while minimizing a lower-level fine-tuning loss.

8. The computing system of claim 6, wherein training the Bilevel data selector comprises:
initializing a data selector parameter;
initializing an auxiliary model parameter;
updating a model parameter based on the safe training samples, the test training samples, a penalty function, and the data selector parameter;
updating the auxiliary model parameter based on gradient descent; and
updating the data selector parameter based on the model parameter and the auxiliary model parameter.

9. The computing system of claim 6, wherein training the Bilevel data selector comprises:
initializing a data selector parameter;
updating a model parameter based on the safe training samples, the test training samples, a penalty function, and the data selector parameter; and
updating the data selector parameter based on the model parameter.

10. The computing system of claim 6, wherein the one or more desired responses indicate a refusal or inability to answer the unsafe queries.

11. A method comprising:
receiving training samples including responses to queries; and
ranking the training samples using a bilevel data selector, wherein the Bilevel data selector comprises a language model that uses a bilevel optimization to rank the training samples.

12. The method of claim 11, wherein the Bilevel data selector ranks the training samples based on one of a safety of the responses, a compliance of the responses to a legal or industry standard, or a correctness of the responses.

13. The method of claim 12, wherein the Bilevel data selector ranks the training samples based on the safety of the responses, wherein the training samples that have the responses indicating a refusal or inability to answer unsafe questions are ranked higher than the training samples that answer the unsafe questions.

14. The method of claim 13, further comprising:
filtering the ranked training samples; and
fine-tuning a large language model (LLM) that is safety aligned using the filtered training samples.

15. The method of claim 14, wherein the LLM was previously trained to be safety aligned, wherein performing the fine-tuning using the filtered training samples keeps the LLM safety aligned.

16. The method of claim 14, wherein the fine-tuning is a post-training process that customizes the LLM to be used for a particular application.

17. The method of claim 11 further comprising:
filtering the ranked training samples; and
pre-training an untrained LLM using the filtered training samples.

18. The method of claim 17, wherein the pre-training trains the untrained LLM to be safety-aligned.

19. The method of claim 18, wherein a safety-aligned LLM provides one or more desired responses to unsafe queries submitted by a user.

20. The method of claim 19, wherein the one or more desired responses indicate a refusal or inability to answer the unsafe queries.
